(19) United States
(12) Patent Application Publication
(10) Pub. No.: US 2015/0100516 A1
(43) Pub. Date: Apr. 9, 2015

(54) METHOD OF ANALYZING AND SCORING COSMETIC PRODUCTS

(71) Applicants: Kevin Hicks, Denver, CO (US); Kevin Byrne, Denver, CO (US)

(72) Inventors: Kevin Hicks, Denver, CO (US); Kevin Byrne, Denver, CO (US)

(21) Appl. No.: 14/047,995

(22) Filed: Oct. 7, 2013

(51) Int. Cl. G06Q 30/02

(52) U.S. Cl. CPC G06Q 30/0282
USPC 705/347

(57) ABSTRACT

A method, apparatus, and computer readable storage medium to implement a cosmetic product data warehouse and rating system. Cosmetic products can be analyzed by a laboratory for their chemical contents and such data can be stored on a secure computer database. A certification authority can retrieve the contents and perform computations on them to determine a numerical score indicating a desirability of the cosmetic product in view of a particular condition. The scores can then be distributed publicly by placing them on labels on bottles of cosmetic products and/or distributed to shoppers on an electronic database.

### BACKGROUND OF THE INVENTION

1. Field of the Invention

The present general inventive concept is directed to a method, apparatus, and computer readable storage medium directed to analyzing and scoring cosmetic products.

2. Description of the Related Art

Since cosmetic products are not highly regulated by the Food and Drug Administration (FDA), the labeling of cosmetic products does not convey to consumers valuable content information that could be used in purchasing decisions. There are a number of ways that cosmetic producers can bring a product to market without significant product testing or disclosure as to ingredients or adverse effects.

Section 510(k) of the Food Drug and Cosmetic (FD&C) Act specifically provides a method for a product to be cleared simply by comparing it to another product on the market. Adverse test results do not need to be disclosed. Further, claims as to effectiveness do not need to be supported. A product can be sold with a statement such as “WARNING—The safety of this product has not been determined.” Information about product safety can be determined by third parties other than the manufacturer and provided to consumers. However, the information must be organized and presented in an accessible manner to a prospective consumer. Analysis and ratings that are presented in a comparative manner are more easily understood than concentration or weight-basis raw data. Providing context and rankings is needed to make chemical analysis results useful to consumers.

The cosmetic industry is largely self-regulated. The Cosmetic Toiletry and Fragrance Association (CTFA) is tasked with ensuring the safety of cosmetic products. The CTFA pays a panel of scientists to regulate the safety of the industry. The resulting regulations are recommendations and are not required to be followed.

For cosmetic products that are designed to produce a particular benefit or result, this is often achieved through the use of an active ingredient. The amount of active ingredients or functional ingredients is often not disclosed on a product label.

Some cosmetic product ingredients are known or suspected of causing cancer. However, no labeling requirements make the disclosure of this information mandatory. Additionally, some cosmetic products contain ingredients that are considered allergens. Again, there is no requirement for disclosure or labeling for allergens. Toxins, such as lead are contained in some cosmetics, including lipsticks. It is not required to disclose the presence of these components or other toxic compounds. Still other cosmetic product ingredients are disruptive to the reproductive system of males or females or cause reduced fertility. The disclosure of any of these effects is not required.

Fragrances such as cologne or perfume are often devoid of any ingredient labeling. Manufacturers can claim that the blend of ingredients is a trade secret and thereby avoid disclosing the contents of the cosmetic product. This can be harmful to consumers who are not aware that a fragrance product contains acetone or benzaldehyde.

The 510(k) approval process has resulted in a large number of cosmetic consumer products being marketed and sold without sufficient disclosure as to the ingredients or the effect of the ingredients consumers will ultimately apply to their bodies.

What is needed is a mechanism to keep consumers educated with regards to the contents of cosmetic products and the risks they may pose to users.

### SUMMARY OF THE INVENTION

It is an aspect of the present invention to provide a way to implement a scoring system for cosmetic products.

The above aspects can be obtained by a method that includes (a) testing a product for the ingredients contained with the product; (b) storing components of interest and their respective quantities in a computer accessible database; (c) executing computer readable instructions on an electronic processing unit that perform the following operations: (d) receiving ingredients, for a subject cosmetic product, the ingredients comprising a plurality of components. and their respective quantities or intensities; (e) accessing established risk data, risk data comprising a plurality of numerical elements established by a scientific advisory board; (f) applying the risk data to the component quantity or intensity data to determine a cumulative score; (g) determining a ranking of the cumulative score among a field of cosmetic products; and (h) outputting the ranking.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method to distribute analyzed components of a cosmetic product and their respective risk elements across the internet, according to an embodiment;

FIG. 2 is a network diagram illustrating participants of a computer communications network, according to an embodiment;

FIG. 3 is a flowchart illustrating an exemplary method of computing a cumulative health risk score for a particular cosmetic product, according to an embodiment;

FIG. 4 is a flowchart illustrating an exemplary method of computing a cumulative allergen risk score for a particular cosmetic product, according to an embodiment;

FIG. 5 is a flowchart illustrating an exemplary method of computing a cumulative effectiveness score for a particular cosmetic product, according to an embodiment;

FIG. 6 is a flowchart illustrating an exemplary method of computing a cumulative organic score for a particular cosmetic product, according to an embodiment;

FIG. 7 is a flowchart illustrating an exemplary method of calculating a grade for a cosmetic product. according to an embodiment;

FIG. 8 is a drawing illustrating how information can be presented to a prospective consumer, according to an embodiment;

FIG. 9A is a drawing of hardware used to distribute information about cosmetic products throughout the internet, according to an embodiment;

FIG. 9B is a drawing of a sample web page which outputs ranking and other information about cosmetic products to a user, according to an embodiment; and

FIG. 10A and FIG. 10B are a block diagrams of hardware that can be used to implement an electronic computer and network, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to analyze cosmetic products and compute numerical scores for the cosmetic products in view of a number of different considerations of import to a prospective consumer. Effectiveness of a particular product is determined by the ingredients. Some ingredients such as moisturizers are not considered medically active ingredients. However, the nature of ingredients and their respective amounts will determine the effectiveness of the product. Other ingredients are considered active ingredients and the amount of each component on a weight or volume percentage basis will also determine the effectiveness of the cosmetic product. Effectiveness is an important consideration for consumers.

Many cosmetic products, including fragrances contain ingredients that are not disclosed on the label. These ingredients can include components that pose a health risk. Consumers are not informed as to the potential health risk where the components of a particular product are not disclosed. Consumers are therefore unable to determine any health risk posed by a particular product. Further, consumers are unable to compare the health risk of one product against another. The present inventive concept provides numerical scores on a variety of health risks including cancer risk, allergen contents, reproductive risk, and the presence of toxins. These numerical scores are informative on their own, but they can be converted into a relative ranking and a grade for ease of comparison by a consumer. Relative ranking are used to determine a Healthy an AllergenGrade, an OrganicGrade, and an EffectiveGrade. All of these grades can be combined to yield a cumulative grade or summary grade for ease of comparison. The scores and grades are published and/or distributed so that consumers can easily access these scores when making decisions as to which cosmetic products to purchase. Scores (any score, rating, data, etc., described herein) can be published using any electronic medium (e.g., distributed on a web site to be displayed on an electronic output display such as an LCD), published on physical labels to accompany the cosmetic product, or published in a magazine or trade journal, etc.

The inventive concept enables the distribution of analytical data to produce effectiveness and health risk ratings for consumers so they are able to make more informed decisions when selecting cosmetic products for purchase or use. An advisory panel determines which components may be present in a cosmetic product that would impact effectiveness or pose a health risk. These components are tested by a laboratory which may or may not be owned by a certification authority to produce verifiable analytical data as measured by the mass quantity present in a particular cosmetic product, e.g. 6 milligrams of benzaldehyde in an ounce of hand cream. This health risk information in the form of ingredients, additives, carriers, and preservatives (“components”) is stored in a database on an Internet Server. The Scientific Advisory Board also establishes risk elements for each component. These risk elements are detailed in the discussion of each grade below. The Web Server is accessed over the network by the company, including but not limited to the advisory panel, which produces consumer designations in the form of effectiveness and health risk ratings (SafeGrade, AllergenGrade, OrganicGrade, and EffectiveGrade) which allow consumers of cosmetic products to quickly and easily determine which beverages are most effective or pose the least health risk.

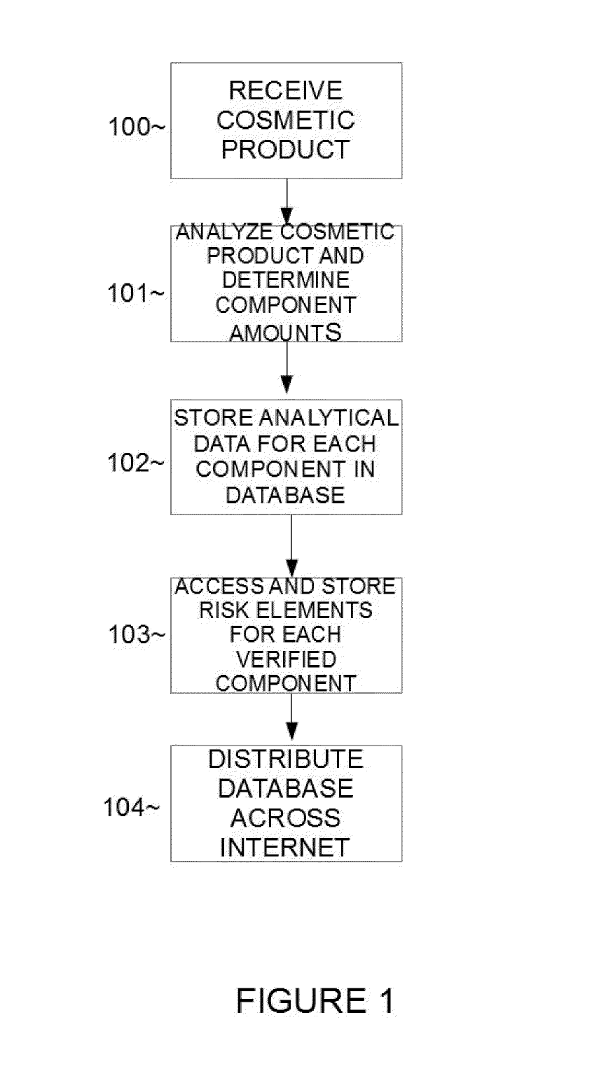

FIG. 1 is a flowchart illustrating a method to distribute verified components of cosmetic products across the internet, according to an embodiment.

The method can begin with operation 100, in which a party such as a laboratory or a lab testing facility (“LTF”) receives a physical quantity of a cosmetic product that is provided to them (e.g., in the mail, etc.) Each cosmetic product is defined by a cosmetic category which is a general category (e.g., skin care, sun care, oral care, hair care, makeup, fragrance, baby care, men's care, etc.), a subcategory (for skin care, examples include cleansers, skin treatments, moisturizers, etc.), a brand (such as the product manufacturer), and a product identifier (e.g., the unique name of the product). For example, ACME ruby red lipstick #3 would be category makeup, subcategory lips or lipstick, brand ACME, and unique name of product “ACME ruby red lipstick #3.”

Each category will typically contain several subcategories of products, for instance category sun care includes subcategories sun screen, self tanning applications, and tanning oils. Makeup includes products for the face, eyes, lips, and nails. In an embodiment, a subcategory cannot belong to more than one category. Each subcategory of product, such as sunscreen, would belong to only one category, such as sun care. Different subcategories of makeup will be contained in the category ‘makeup.’ A brand identifies the unique source of a particular product (which has a category and subcategory). The product identifier identifies the particular product (e.g., both the product identifier and the particular product are “ACME ruby red lipstick #5”). For instance the category makeup contains subcategories such as lipstick and lip gloss. The product identifier is a particular product that would fall under a category and subcategory, and the brand would identify a manufacturer of the product identifier such as ABC brand lip gloss (the product which falls under the category makeup and subcategory lip gloss). Different manufacturers can make their version of the same category/subcategory. As another example, a particular cosmetic product can be subcategory shampoo in the category baby care, the product identifier “Dazzle extra shine shampoo” and the brand XYZ. Any cosmetic product that is analyzed and subject to the analysis described herein is going to be a particular brand of a particular category and a particular subcategory (e.g., ABC (brand) makeup (category) mascara (subcategory) and identified by the product identifier.

From operation 100, the method proceeds to operation 101, wherein the laboratory or LTF analyzes the ingredients of the cosmetic product to determine its exact components and the quantity of each component. Anywhere “quantity”, “amount” or “concentration” is used herein, these terms can be substituted with intensity. The intensity is the area under the curve on a chromatogram, spectra or other lab methodology. The intensities for each compound is compared against each beverage in a category and class. That way, the measurements will be accurate based on the ratios of one compound in a beverage versus another compound in a beverage. For example, beverage A has an intensity of 10,000 units. Even though we don't know how many exact grams, mL etc. that is, when compared to another beverage B with 20,000 units, we then know that Beverage A has half as much of the particular compound as Beverage B. Since we are grading on a Gaussian curve, ultimately, the grades will be the same (exact measurement or intensity ratios).

This can be done using any analytical chemical methods known in the art, or newly discovered analytical technique.

The quantities of all components are standardized, and then converted to a standard weight percentage.
Components in a cosmetic product can include (but are not limited to) allergen components (e.g., Casein (milk protein), egg/egg whites, Gliadin (gluten), and Milk-total). Components can also comprise chemistry components (e.g., Coal Tar: A research study in 2001 by the USC School of Medicine found that women using permanent hair dye at least once a month more than doubled their risk of bladder cancer. The study estimates that “19 percent of bladder cancer in women in Los Angeles, Calif., may be attributed to permanent hair dye use.”
Heavy Metals: including lead, chromium, mercury and arsenic. A 2007 study by the FDA found that 61% of the lipsticks they tested contained lead.
BHA (Beta Hydroxy Acids): Suspected endocrine disruptors and may cause cancer
Dibutyl phthalate: Plasticizer in nail care products. Suspected endocrine disruptor and reproductive toxicant.
Formaldehyde-releasing preservatives: Includes DMD, hydantoin, diazolidinyl urea, methanamine and quarternium-15. Causes cancer (DavidSuzuki.org)
Parabens: endocrine disrupters and male reproductive damage (DavidSuzuki.org)
Parfum (e.g. fragrance): Can trigger allergies and asthma; linked to cancer and neurotoxicity
PEG compounds: Contaminated with a known carcinogen, 1-4 dioxane. Also for related chemicals propylene and glycol and other ingredients with the letters “eth”, e.g. polyethylene glycol
Petrolatum: May cause cancer
Siloxanes: Ingredients ending in “siloxane” or “methicone”, they are used to soften, smooth and moisten. Suspected endocrine disruptor and reproductive toxant
Sodium Laureth Sulfate: Used in foaming cosmetics, e.g. shampoos, cleansers and bubble bath. Contaminated with 1,4 dioxane, a known carcinogen. Look for chemical sodium lauryl sulfate and other ingredients with the letters “eth” (e.g. sodium laureth sulfate)
Triclosan: Suspected endocrine disrupter and may contribute to antibiotic resistance in bacteria
   Note that the above components are merely examples and any other components can be analyzed and measured as well in order to be used in the composite scores discussed herein. Note that components would typically be a subset of the ingredients in a given cosmetic product. Components can be considered ingredients of interest. Water, for instance, is present in many products, but is generally regarded as safe to humans and without any practical effect when applied to the skin. Thus, although water is a common ingredient, it would not likely be considered a component.

From operation 101, the method proceeds to operation 102, wherein the analytical data comprising the components and their quantities (or intensity ratios) determined from operation 101 is stored in an electronic database (for each particular cosmetic product analyzed). This can be performed by the laboratory or a certification authority that received analytical data containing all the components and respective quantities from the laboratory or LTF.

Thus, all cosmetic products that have been analyzed in operation 101 are added to the database and can be accessed and searched. Any type of database, such as a SQL database can be used which can accommodate any type of query. For example, a particular cosmetic product can be queried for its components. Alternatively, the database can return all cosmetic products of a particular category and/or subcategory and/or brand and their respective components. Any structured query can be used with the database.

From operation 102, the method proceeds to operation 103, wherein the risk elements for each component are accessed and stored in the database. Each component will be assigned risk elements by the Advisory Board (or any other source). Some components present a risk of cancer, some components are toxic, some components present a risk of allergic reaction, etc. The risk data elements are based on scientific research and judgment and can be adjusted based on new information. If a component is not toxic, it will have a low value assigned to its toxicity. However, if a component is known to be highly toxic, a high value will be associated with the component's toxicity representing a higher health risk. The Scientific Advisory Board will base its determinations on certification authorities which can include peer-reviewed journals, research associations, and government agencies to determine risk elements. Thus, in operation 103, a risk element for each component from operation 102 is retrieved from a database/source and also stored in the database used to store component amounts in operation 102 indexed along with the respective product. The risk element stored for a product can take into consideration the amount/concentration of the component (e.g., some components may have little or no risk at low amounts but can be high risk at high amounts).

From operation 103, the method proceeds to operation 104, wherein the components and associated risk data stored in the electronic database are made publicly available on the internet (such as using a web server). Thus, any user can visit a web site operated by the Scientific Advisory Board which publishes component levels, amounts, or concentrations for all tested cosmetic products, and also respective risk elements for all components in product from operation 103. Thus, a user can initiate a query for a particular cosmetic product and retrieve (display) its components, each component's amounts and concentrations (or relative intensity), and a risk element for each component and the component's amounts and concentrations.

The database will also compute (using any of the methods described herein) and make available on the database any score, cumulative score, grade, ranking, etc., described herein of any and all cosmetic products known to the database.

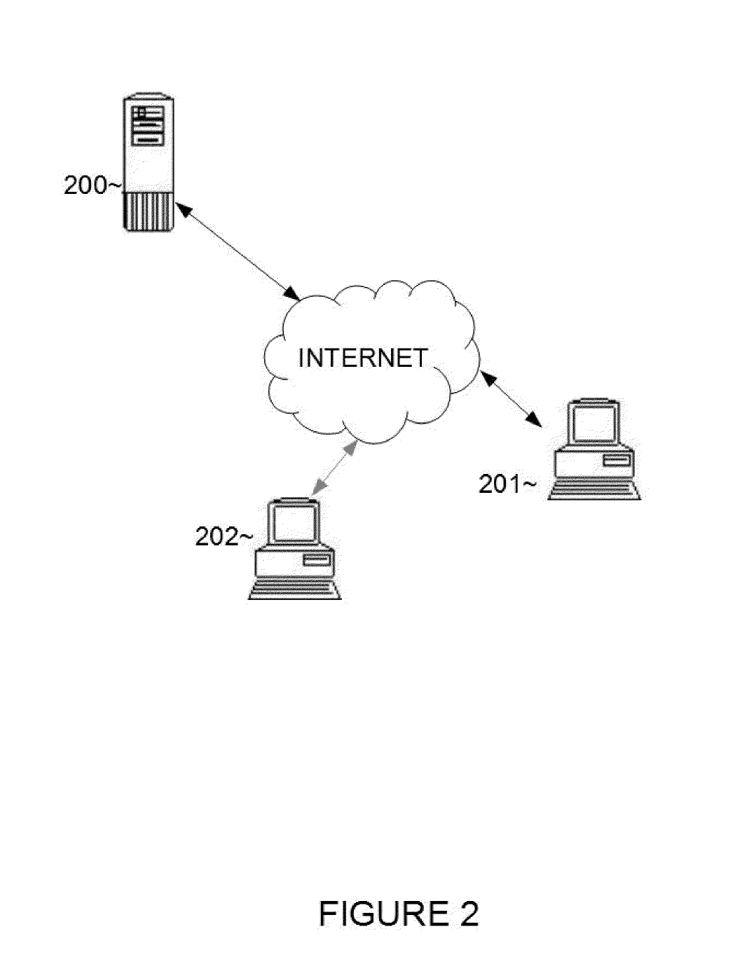

FIG. 2 is a network diagram illustrating participants of a computer communications network, according to an embodiment.

A server 200 is connected to the internet and also serves as a database (or is connected to a database) described in operations 102-104. The server makes available all values known to the database to any remote user 201, 202 on the internet. Remote users can type in a particular cosmetic product (e.g., “BRAND, and/or CATEGORY, and/or SUBCATEGORY” and/or PRODUCT IDENTIFIER, wherein BRAND is the maker or manufacture of the product, category is general type of product defined herein, and the subcategory is the specific type of product defined herein. Remote users can retrieve the components for that product (e.g., a list of all (or any subset) of the components and their respective quantity) for that cosmetic product. In a further embodiment, in addition (or in the alternative) to displaying the respective quantity for each (or some) components in a cosmetic product, a discrete quantity rating can be assigned for each component based on that component's quantity in the product. For example, for the component lead, a three star (best/better than average) rating can be assigned for quantities of less than 15 parts per billion (ppb), a two star rating (fair/average) can be assigned for quantities of 15-30 ppb, and a one star rating (worst/below average) can be assigned for quantities of over 30 ppb. Each component can have its own range of quantities and respective amount of stars (which would be different for different components). In this way, information regarding the quantity of each components (e.g., a discrete rating) can be presented in a visually easy to understand manner (since the majority of users may not appreciate whether a specific quantity of a component is good or bad).

In addition, to make available component data, a score for a particular cosmetic product can be computed using the product's components and their respective quantities in the product as determined in operation 101 and then computed based on the relative risk that the component presents to a human. There are many factors that contribute to the health risk or relative safety of a particular product. Consumer products contain many ingredients. This method is primarily concerned with ingredients that may pose a health risk. These ingredients of interest are referred to as components herein. Each component further has an array of possible effects. Some components are known endocrine disruptors, some are known to be toxic, some are known to cause cancer, and others are active ingredients that provide a beneficial effect at low levels, but present a health risk at higher concentrations and exposures. In addition, accuracy in labeling is important to consumers as well. The method will determine if components are present at harmful levels as well as determine if components are present in the levels indicated on the product label. The method determines health risk and safety by establishing risk elements for each component based on the risk data and established by the Scientific Advisory Board. The algorithm generally calculates a score for each component present in the product. Then, the individual scores are summed to provide a cumulative score. Cumulative scores can be calculated for the allergen risk and health risk as well as methods to evaluate the organic compliance of a product and the presence of effective ingredients in a product. These cumulative scores are calculated based on risk elements, analytical data, and an appropriate algorithm which will be discussed herein.

Calculation of a health risk score. Each component is evaluated for different risks for calculation of a health risk score. Each component that is present in a cosmetic product is assigned a health risk weighting. Health risk weightings are a subset of risk elements established in step 103 of FIG. 1. For a given criteria such as cancer, components are given a risk weighting based on available scientific evidence. Again, for cancer, components that are known or probable causes of cancer are considered high risk and given a risk weighting of, for example 5. Components that are suspected of causing cancer, but lack sufficient or conclusive scientific evidence are considered medium risk and given a health risk weighting of, for example, 2. Components that are not considered to be causes of cancer are considered low risk and are given a lower health risk weighting of, for example, 0. Table 1 presents in text form the different risks associated with a few representative components.

TABLE 1
Health Risk Weighting

| | | Birth Defect/ | | | |
|---|---|---|---|---|---|
| Ingredient | Cancer | Reproductive | Neuro | Endocrine | Immune |
| Coal Tar Pitch | High | Low | Low | Low | Med |
| Lead | High | High | High | Med | Low |
| Mercury | Low | Med | Med | Med | Med |
| Arsenic | High | High | Med | Med | Med |
| Formaldehyde | High | Low | Med | Low | High |
| 1,4-Dioxane | High | Low | Low | Low | Low |
| N- | High | Low | Low | Low | High |
| Nitrosodimethylamine | | | | | |
| (NDMA) | | | | | |
| Benzophenone-3 (Bp- | Low | Low | Low | High | Low |
| 3) | | | | | |
| Lonolin (DDT- | High | High | Med | High | Med |
| released) | | | | | |

Table 2 below presents the numerical risk weighting or weights (higher numbers represent greater risk) assigned to each of these components. The risk weighting is assigned by the scientific panel and is subject to change and revision based on scientific evidence and judgment.

TABLE 2
Health Risk Weighting Numerical Values

| | | Birth Defect/ | | | |
|---|---|---|---|---|---|
| Ingredient | Cancer | Reproductive | Neuro | Endocrine | Immune |
| Coal Tar Pitch | 5 | 0 | 0 | 0 | 2 |
| Lead | 5 | 5 | 5 | 2 | 0 |
| Mercury | 0 | 2 | 2 | 2 | 2 |
| Arsenic | 5 | 5 | 2 | 2 | 2 |
| Formaldehyde | 5 | 0 | 2 | 0 | 5 |
| 1,4-Dioxane | 5 | 0 | 0 | 0 | 0 |
| N- | 5 | 0 | 0 | 0 | 5 |
| Nitrosodimethylamine | | | | | |
| (NDMA) | | | | | |
| Benzophenone-3 (Bp- | 0 | 0 | 0 | 5 | 0 |
| 3) | | | | | |
| Lonolin (DDT- | 5 | 5 | 2 | 5 | 2 |
| released) | | | | | |

Note that the risk weightings are independent from any consideration of any cosmetic product. Many components that are known health risks are not banned from cosmetic products.

Additionally, the exposure route to the user is an important aspect of health risk. If the component can be absorbed through the skin, it is given an exposure weight that is higher, for example 1.5. Table 3 shows an example of different exposure weight values assigned to different exposure routes.

TABLE 3
Exposure Weights.

| Exposure Route | Exposure Weight |
|---|---|
| Skin Absorption | 1.5 |
| Skin/Eye Contact | 1.0 |
| Inhalation | 1.0 |
| Other | 1.0 |

The scientific panel can assign different numerical values based on additional evidence and investigation. These numbers are illustrative. The algorithm considers any ingredient in the cosmetic product that will absorb through the skin to make all of the components in the product viable for this exposure route. Thus a component or ingredient may not pose a health risk itself, but it may help to carry other components through the skin or other exposure routes. The algorithm multiplies the risk weighting of all components in a given product by the exposure weighting if any ingredient or component with an exposure weight greater than 1.0 is present in the product.

TABLE 4
Exposure Route Examples

| | Skin | Skin and/or | | |
|---|---|---|---|---|
| Ingredient | Absorption | Eye Contact | Inhalation | Other |
| Coal Tar Pitch | No | Yes | Yes | Yes |
| Lead | No | Yes | Yes | Yes |
| Mercury | Yes | Yes | Yes | Yes |
| Arsenic | Yes | Yes | Yes | Yes |
| Formaldehyde | No | Yes | Yes | No |
| 1,4-Dioxane | Yes | Yes | Yes | Yes |
| N- | Yes | Yes | Yes | Yes |
| Nitrosodimethylamine | | | | |
| (NDMA) | | | | |
| Benzophenone-3 (Bp- | No | Yes | Yes | No |
| 3) | | | | |
| Lonolin (DDT- | Yes | Yes | Yes | Yes |
| released) | | | | |

The algorithm next considers the thresholds for components to cause harm. While scientific detection limits can be quite low, and in some cases less than one part per billion, lower concentrations are not likely to cause significant health risk in many instances unless they surpass a concentration threshold. Points are assigned as Low Threshold=0 points, Medium Threshold=10 points, and High Threshold=50 points.

Table 5 presents exemplary thresholds for the components shown in the previous tables.

TABLE 5

| | Maximum | Low | | |
|---|---|---|---|---|
| | Contaminant | Threshold | Medium | High |
| | Level Goals | (0 | Threshold | Threshold |
| Component | (MCLG) | points) | (10 Points) | (50 Points) |
| Coal Tar Pitch | .2 ppm or 200 | <=200 ppb | 200 < X <= 400 | >400 ppb |
| | ppb (parts per | | ppb | |
| | billion) | | | |
| Lead | 15 ppb | <=15 ppb | 15 < X <= 30 | >30 ppb |
| | | | ppb | |
| Mercury | 2 ppb | <=2 ppb | 2 < X <= 10 ppb | >10 ppb |
| Arsenic | 10 ppb | <=10 ppb | 10 < X <= 20 | >40 ppb |
| | | | ppb | |
| Formaldehyde | 20 ppb | <=20 ppb | 20 < X <= 40 | >40 ppb |
| 1,4-Dioxane | 300 ppb | <=300 ppb | 300 < X <= 600 | >600 ppb |
| N- | 1 ppb | <=1 ppb | 1 < X <= 5 ppb | >5 ppb |
| Nitro- | | | | |
| sodimethyl- | | | | |
| amine | | | | |
| (NDMA) | | | | |
| Benzophenone- | 9 ppb | <=9 ppb | 9 < X <= 18 | >18 ppb |
| 3 (Bp-3) | | | ppb | |
| Lonolin (DDT- | 60 ppb | <=60 ppb | 60 < X <= 120 | >120 ppb |
| released) | | | ppb | |

These values are merely illustrative and are subject to change.

Table 6 presents an illustration of the elements of the algorithm for one particular cosmetic product. The product has been tested and contains the components shown in Table 1. Further, the Health Risk Weighting is shown in Table 2 and the exposure routes are shown in Table 4. In Table 6, the Risk Weighting column is determined from Table 2 by adding up the values in each respective row. The exposure weighting column is determined from Table 3. The lab tested component quantity is determined from operations 101/102. The threshold Points column is determined from Table 5 using the value in the Lab Test Component Quantity row for that component. Each Health Risk Score is computed by multiplying the risk weighting (a cumulative risk weighting which is the sum of all health risk weighting numerical values for each respective component/ingredient as in Table 2), exposure weighting, and threshold points in the same column. The Health Risk Score represents an overall risk of each respective component for a particular product.

TABLE 6

| | | | Lab Tested | | Health |
|---|---|---|---|---|---|
| | | Exposure | Component | Threshold | Risk |
| Component | Risk Weighting | Weighting | Quantity | Points | Score |
| Coal Tar Pitch | 5 + 0 + 0 + 0 + 2 = 7 | 1.0 | 300 ppb | 10 | 70.0 |
| Lead | 5 + 5 + 5 + 2 + 0 = 17 | 1.0 | 35 ppb | 50 | 850.0 |
| Mercury | 0 + 2 + 2 + 2 + 2 = 8 | 1.5 | 20 ppb | 50 | 600.0 |
| Arsenic | 5 + 5 + 2 + 2 + 2 = 16 | 1.5 | 2 ppb | 0 | 0.0 |
| Formaldehyde | 5 + 0 + 2 + 0 + 5 = 12 | 1.0 | 18 ppb | 0 | 0.0 |
| 1,4-Dioxane | 5 + 0 + 0 + 0 + 0 = 5 | 1.5 | 50 ppb | 0 | 0.0 |
| N- | 5 + 0 + 0 + 0 + 5 = 10 | 1.5 | 0 ppb | 0 | 0.0 |
| Nitrosodimethyl- | | | | | |
| amine (NDMA) | | | | | |
| Benzophenone- | 0 + 0 + 0 + 5 + 0 = 5 | 1.0 | 30 ppb | 50 | 250.0 |
| 3 (Bp-3) | | | | | |
| Lonolin (DDT- | 5 + 5 + 2 + 5 + 2 = 19 | 1.5 | 101 ppb | 10 | 4,560.0 |
| released) | | | | | |
| Cumulative | | | | | 6,330.0 |
| Health Risk | | | | | |
| Score | | | | | |

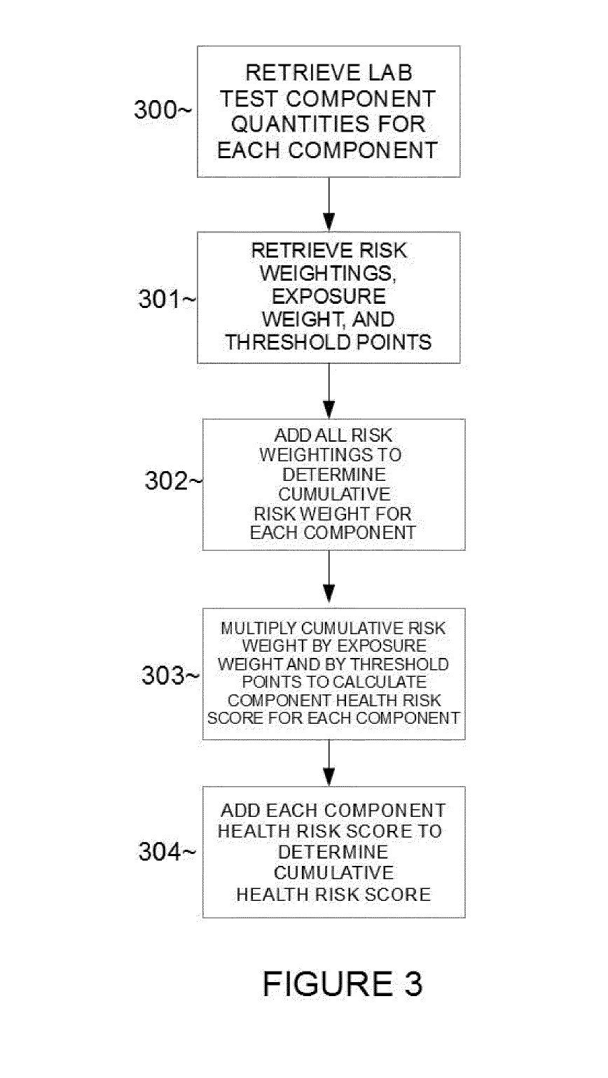

FIG. 3 is a flowchart illustrating an exemplary method of computing a cumulative health risk score for a particular cosmetic product, according to an embodiment. The cumulative health risk score is computed by an electronic computer that has access to the inputs required (the components present in a product, the lab tested component quantities, the risk weightings, the exposure weights, and threshold points). In operation 300, the electronic computer retrieves components present in the cosmetic product. This can be done in numerous ways, for example the components can be stored on a server/database (e.g., server/database 200 of FIG. 2) and can be automatically retrieved by automatically querying (via the internet) the server/database 200 with an identification of the cosmetic product so that the server/database 200 would respond with the respective components present in the product. If the server/database 200 is the computer performing these calculations, then it has access to the components and need not query for them over the internet. Multiple components for each product can be returned.

The method then proceeds to operation 301 which retrieves the risk weightings, the exposure weights, and threshold points for each component present in the cosmetic product. These risk elements can be stored locally on a server/database 200 or retrieved via the internet (as described for operation 300).

The method then proceeds to operation 302 where all risk weightings for each component are added to determine a cumulative risk weight for each component.

The method then proceeds to operation 303 where the cumulative risk weight is multiplied by both the exposure weight and by the threshold points to calculate a component health risk score. Component health risk scores, or, the health risk score for each component, are shown in Table 6. The component health risk score can be computed by any computer described herein and operated by any party (e.g., the advisory panel, the laboratory, a certifying authority whose role is to compute and distribute composite scores, private parties, etc.). A component health risk score is calculated for each component as shown in the rows of Table 6. The method then proceeds to operation 304 where each of the component health risk scores for a particular product are summed to determine a cumulative health risk score. The cumulative health risk score represents an overall health score for a particular product considering all of its components/ingredients. The cumulative health risk score can be computed by any computer described herein and operated by any party described herein (e.g., the advisory panel, the laboratory, a certifying authority whose role is to compute and distribute composite scores, private parties, etc.). Typically, the lower the cumulative health risk score, the better.

Cumulative health risk scores for all tested cosmetic products (all categories, subcategories, and brands) would be computed and stored in an electronic database (e.g., server 200 or other computer). Each cumulative health risk score is stored in the database along with an identifier identifying its respective cosmetic product, so each product's scores can easily and quickly be retrieved. Thus, when all testing is completed, the database would have every tested cosmetic product's score, and the scores can be compared with their respective field. When new cosmetic products are released by manufacturers, then the new cosmetic products would also be tested as illustrated in FIG. 1 and scored for health risk as illustrated in FIG. 3. Cosmetic products that are no longer being sold can be removed from the database or marked as “inactive” so that that when relative rankings are computed the rankings would typically not include old cosmetic products that are no longer sold on the market.

Once the database is populated with the cumulative health risk scores, this information can be used to compare any subject cosmetic product against different fields (groups of other cosmetic products). Fields can be, for example, all cosmetic products, only all cosmetic products of a same category (or certain categories) as the subject, only all cosmetic products of a same subcategory (or certain subcategories), or any field which can be chosen as a subset of all cosmetic products. Fields, as known in database queries, are used to determine and display the comparative percentiles/rankings as described herein.

While subject to modification or addition, exemplary categories of products include skin care, sun care, oral care, hair care, makeup, fragrance, baby care, and men's care. Within the category of skin care, subcategories antiperspirant, deodorant, bar soap, hand sanitizer, liquid hand soap, liquid facial soap, acne treatment, anti-fungal treatment, and others can be included. In the category of sun care, the subcategories of self tanning, sunscreen, and tanning oils can be included. In the category of sun care, the subcategories of self tanning, sunscreen, and tanning oils can be included. In the category of oral care, the subcategories of toothpaste, mouthwash, and whitening preparations can be included. In the category of hair care, the subcategories of shampoo, conditioner, dyes, polish, and treatments can be included. In the category of makeup, the subcategories of facial, eyes, lips, and nails can be included. In the category of baby care, the subcategories of shampoos and sun care can be included. In the category of men's care, the subcategories of face, body, and hair can be included. The foregoing list is exemplary and additional products can be included as desired. A product identifier will only have one brand, one category and one subcategory. In another embodiment, a product identifier can fall under more than one categories and/or more than one subcategories. For example, a product identifier of ACME baby shampoo (brand ACME), the category can be baby and the subcategory can be shampoo and also the category can be shampoo and the subcategory can be baby.

In an embodiment, a field can be set up as any group of cosmetic products that contain one or more properties (e.g., that are the result of a relational database query, such as “mascara costing less than $6, etc.) and each field can also exclude any one or more properties. A user can specify a custom field to compare a particular cosmetic product (the subject) against (which also requires a condition) by using relational calculus or relational algebra which are well known in the database art. There is no limit to the complexity of queries that can define the field. For example, the field can be all shampoos and sun care products for men that have the active ingredient Retin A and are completely lead-free. All values about every cosmetic product are stored in the database (all components, respective quantities) which can include other data as well which can come from the manufacturer/distributor (e.g., suggested retail price) which can be accessible by the database system and used for any possible query. When cosmetic products are stored in the database, they are also stored with their category, subcategory, brand, name, and unique identifier (which can also be a unique identifying number) which can be used to identify the cosmetic product when transmitting/receiving data over the internet or between any computers, suggested retail price, etc.

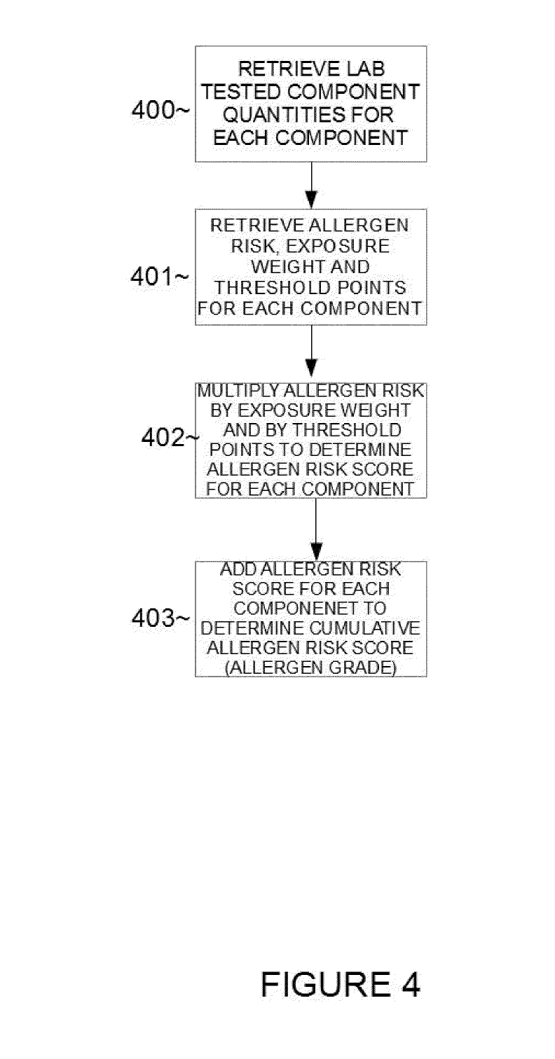

FIG. 4 is a flowchart illustrating an exemplary method of computing an allergen risk score. The calculation of an allergen risk score utilizes the risk data shown in Table 7 below. Each component is assigned an allergen risk based on scientific data with a value of either zero or one. Allergen risk is another subset of risk elements established as part of the method. This binary value is applied in that a component that is not likely to cause an allergic reaction is given a value of zero. A component that is likely to cause a skin irritation or allergen in some people is given a value of one. About ten percent of the USA population experience an allergic reaction to cosmetic products. There are two types of reactions according to MedicineNet and its definitions are provided here: “Irritant contact dermatitis: This is more common than allergic contact dermatitis and can occur in anyone. It develops when an irritating or harsh substance actually damages the skin. Irritant contact dermatitis usually begins as patches of itchy, scaly skin or a red rash, but can develop into blisters that ooze, especially if the skin is further irritated from scratching. It generally occurs at the site of contact with the irritating substance. Areas where the outermost layer of skin is thin, such as the eyelids, or where the skin is dry and cracked are more susceptible to irritant contact dermatitis.”

Allergic contact dermatitis occurs in people who are allergic to a specific ingredient or ingredients in a product. Symptoms include redness, swelling, itching, and hive-like breakouts. In some cases, the skin becomes red and raw. The face, lips, eyes, ears, and neck are the most common sites for cosmetic allergies, although reactions may appear anywhere on the body. As a practical matter, these reactions on the skin of a user are similar in that they cause irritation, discomfort, and harm in the short term. A manufacturer that claims its product is hypoallergenic does not need to prove the claim that the product ingredients are less likely to cause allergies. Thus, third party evaluation and information is needed.

TABLE 7
Allergen Risk Score Example

| | | Expo- | Lab Tested | | Allergen |
|---|---|---|---|---|---|
| | Allergen | sure | Component | Threshold | Risk |
| Component | Risk | Weight | Quantity | Points | Score |
| Coal Tar Pitch | 1 | 1.0 | 300 ppb | 10 | 10.0 |
| Lead | 0 | 1.0 | 35 ppb | 50 | 0 |
| Mercury | 1 | 1.5 | 20 ppb | 50 | 75.0 |
| Arsenic | 1 | 1.5 | 2 ppb | 0 | 0.0 |
| Formaldehyde | 1 | 1.0 | 18 ppb | 0 | 0.0 |
| 1,4-Dioxane | 0 | 1.5 | 50 ppb | 0 | 0.0 |
| N- | 0 | 1.5 | 0 ppb | 0 | 0.0 |
| Nitrosodimethyl- | | | | | |
| amine (NDMA) | | | | | |
| Benzophenone-3 | 1 | 1.0 | 30 ppb | 50 | 50.0 |
| (Bp-3) | | | | | |
| Lonolin (DDT- | 1 | 1.5 | 101 ppb | 10 | 15.0 |
| released) | | | | | |
| Cumulative | | | | | 175.0 |
| Allergen | | | | | |
| Risk Score | | | | | |

An allergen risk weight is assigned by scientific panel and associated in the database in operation 103.

Components likely to cause dermatitis are assigned an allergen risk weight of one. Components not likely to cause dermatitis are assigned an allergen risk weight of zero. Exposure weights are assigned as discussed in Table 3 above. Lab tested quantities are determined as described in FIG. 1. Threshold points are determined as described in Table 5. As shown in FIG. 4, in operation 400 the method retrieves the lab tested component quantities for each component. The method then proceeds to operation 401 wherein the risk elements are retrieved. The allergen risk elements can comprise the allergen risk, the exposure weight, and the threshold points as shown in Table 7. The method then proceeds to operation 402 where the allergen risk is multiplied by the exposure weight, and by the threshold points (computed as described herein) to determine a component allergen risk score, alternatively an ‘allergen risk score’ for each component. The method then proceeds to operation 403 wherein the allergen risk score for each component in a cosmetic product is added to determine the cumulative allergen risk score for the product. Generally, a lower score is more advantageous to the consumer as it indicates a lower risk. The cumulative allergen risk score can also be stored in the database so this computation does not have to be made each time a request is made from the database for the cumulative allergen risk score (e.g., it can be computed initially for a product and stored).

Calculation of effectiveness score. In order to guide consumers as to the effectiveness of a particular product, an effectiveness score is determined. Many products make claims as to the effect produced by use of the product. These claims often assure consumers that there is an active ingredient present in the product that will produce the desired effect. Often the amount or presence of active ingredients is either not disclosed, or inaccurately disclosed on the product packaging. Effectiveness scores help guide a consumer toward a product that is more likely to produce the desired effect. Common to the other methods, risk data elements are assigned by the scientific panel. For an effectiveness claim made by a manufacturer, an effectiveness research score is attributed to the component in the produce. Table 8 below shows the relative scores for two active ingredients, Retin-A and Retinol. Both are effective in “anti-wrinkle” preparations. A scientific panel assembles a list of active ingredients and their effectiveness claims. The panel scores the active ingredients, giving the ingredient an “effective research weight” score between 1 and 10 based on peer-reviewed, scientific literature regarding its effectiveness (wherein higher scores are deemed more reliable than lower scores).

TABLE 8
Effectiveness Research Weight.

| | | Effectiveness | | |
|---|---|---|---|---|
| | | Research | | Maximum |
| Active | Effectiveness | Weight (0- | Effective | Dosage |
| Ingredient | Claim | 10)* | Range | Allowed |
| Retin-A | Anti-wrinkling | 10 | .01% to .1% | .1% |
| Retinol | Anti-wrinkling | 4 | .01% to .1% | .1% |

Weights and numerical values are subject to update, but in this example, an ingredient that is unlikely to be effective based on peer-reviewed, scientific research is given an effectiveness research weight of zero. Active ingredients that are somewhat likely to be effective are given an effectiveness research weight of 4. Active ingredients that are likely to be effective are given an effectiveness research weight of 8. Active ingredients that are very likely to be effective are given an effectiveness research weight of 10. The cosmetic product is analyzed and the data stored according to the operation in FIG. 1. Active ingredients (ingredients of interest) are stored with the other components. If the product is within 15 percent of the labeled quantity, then it is assumed to be accurate. The method includes a quantity tolerance of 15 percent. For lab tested quantities that are greater than 15% different from the labeled quantity, the variance score assigned is zero. For lab tested quantities that are less than or equal to 15% different from the labeled quantity, the variance score assigned is one. For products that advertise or suggest the presence of an active ingredient, but do not provide an ingredient amount, the product can also be evaluated against a minimum dosage required to be effective. Thus, the lab tested quantity of an active ingredient is compared against a minimum dosage retrieved from a database. If the amount present in the product is equal to or greater than the minimum effective dosage, a minimum dosage score of one is assigned. If the amount present in the product is less than the minimum effective dosage, a minimum dosage score of zero is assigned.

Table 9 shows an example of labeled quantity data, lab test quantity data, variance/variance score data, minimum effective dosage data, research weight data, and overall score data for four brands of anti-wrinkle cream. Note that in Table 9, some brands have unlabeled quantities. In these cases, the minimum effective dosage can be provided (based on literature, science organizations, etc.) For example, in the case of Brand B, since 0.25% is the minimum amount of Retin-A required to provide some level of effectiveness, and the lab tested quantity is 0.24%, the difference is only 4%, which means it scores a 1 for the variance score (in other words the minimum effective dosage can be used as the labeled quantity and the difference is within 15%). Thus, Brand B's score in Table 9 is 10 (Brand's research weight)*1 (variance score)=10. If the minimum effective dosage compared to the lab tested quantity (variance) exceeds 15% (or other present amount) then the variance score would be 0. This comparison can be done by taking the larger of (lab tested quantity and minimum effective dosage) and dividing it by the other quantity and subtracting 1. For example, for Brand B, the minimum effective dosage (0.025%) is larger than the (lab tested quantity of 0.024%) so 0.025% is divided y 0.024% resulting in 1.04 which means a 4% (after subtracting 1) variance.

TABLE 9

| | | | Lab | Variance/ | Minimum | Min | | |
|---|---|---|---|---|---|---|---|---|
| | Active | Labeled | Tested | Variance | Effective | dosage | Research | |
| Brand | Ingredient | Quantity | Quantity | Score | Dosage | Score | Weight | Score |
| Brand A | Retin-A | .05% | .03% | −40%/0 | .05% | .4-.15 = .25 > .15 (0) | 10 | 10 * 0 = 0 |
| Brand B | Retin-A | Unlabled | .024% | −4%/1 | .025% | .04-.15 = <.15 (1) | 10 | 10 * 1 = 10 |
| Brand C | Retinol | .1% | .095% | −5%/1 | .1% | .05-.15 = <.15 (1) | 4 | 4 * 1 = 4 |
| Brand D | Retinol | Unlabeled | .0125% | −50%/0 | .025% | .5-.15 = >.15 (0) | 4 | 4 * 0 = 0 |

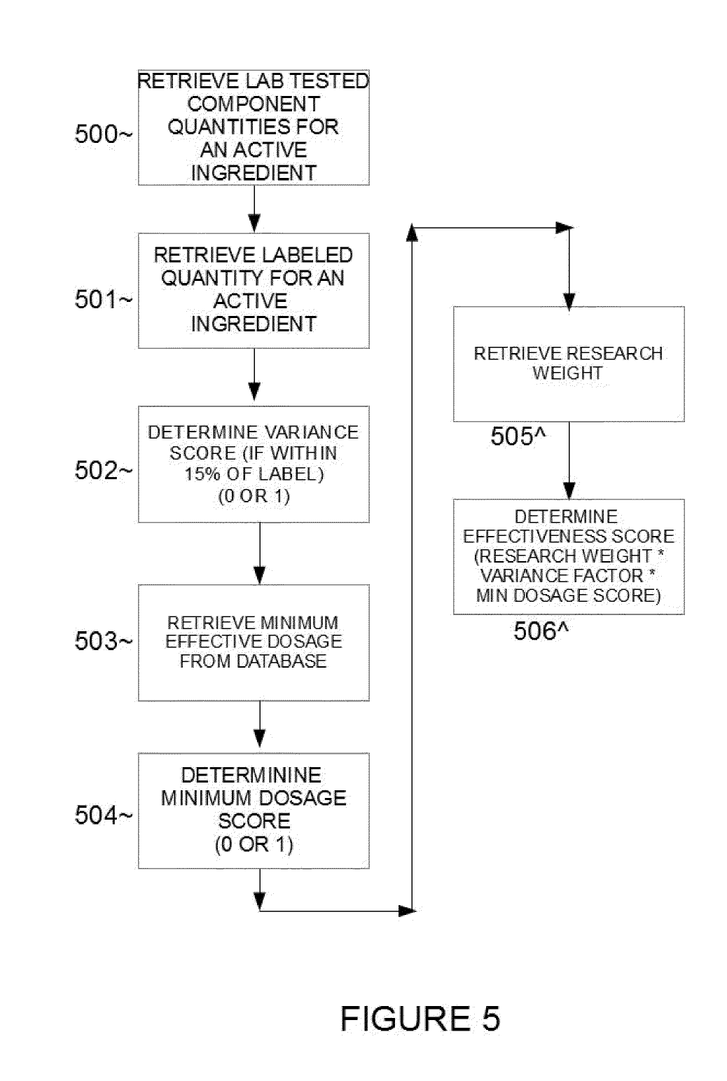

In FIG. 5, it is shown to calculate an effectiveness score, in an embodiment of the invention. In step 500, the lab tested component quantities for an active ingredient are retrieved from a database (wherein the quantities were originally determining using analytical chemistry or other method and entered into the database). In Step 501, the labeled quantity for an active ingredient is retrieved from the database (this was entered into the database based on the label). The method then proceeds to step 502 where a variance score is assigned. Variance score takes into account whether the cosmetic product is labeled accurately (as stated herein, if the comparison (see the preceding paragraph to see how this can be computed by using labeled quantity instead of minimum effective dosage) between the actual quantity and the labeled quantity is within (or equals) the preset tolerance level (e.g., 15%) then the variance score is 1 otherwise the variance score is 0 if the labeled quantity compared to the actual quantity exceeds the preset tolerance level (e.g., 15%). Also, if the product is not labeled with the quantity of the given component, the variance score is assigned as one. The method then proceeds to step 503 where a minimum effective dosage is retrieved from the database. In step 504, a minimum dosage score is assigned by determining if the amount of a component in the product is sufficient to provide the minimum effective dose (i.e., the amount of the component in the product is greater than or equal to the minimum effective dose). If yes, the score assigned is one. If the minimum effective dosage is not met, the minimum dosage score assigned is zero. The method then proceeds to step 505 a research weight is retrieved from the database. The method then proceeds to step 506 where an effectiveness score is determined by multiplying the research weight times the variance score (which must be 0 or 1) times the minimum dosage score (which must be 0 or 1). Higher scores represent more effectiveness and greater accuracy in labeling. Calculating the organic score. Cosmetic manufacturers often make claims regarding their products being all natural or organic products. The all-natural claim can be made by any manufacturer regardless of the amounts of pesticides, herbicides and fungicides (referred to as “Pesticides”) present. FDA “does not define or regulate the term ‘organic’ as it applies to cosmetics, body care, or personal care products” which is very confusing for consumers. A typical consumer would believe that an organic labeling meant it was an organic product. However, unless it is certified-USDA organic, than the regulations for labeling organic are not controlled. Furthermore, even products that are certified-USDA organic can contain pesticides, herbicides, and fungicides. Our invention aims to lab test for the presence of pesticides in organically-labeled skin care products, so that consumers can be assured they are purchasing organic products. The method analyzes pesticides into two classes. The first class contains pesticides that are scientifically proven to cause health hazards based on peer-reviewed journals and agencies including EPA. These are labeled as hazardous pesticides. The second class contains pesticides that are unlikely to cause health hazards based on peer-reviewed journals and agencies including EPA. These are labeled as non-hazardous pesticides. That way, consumers will know whether pesticides are present, and if they are toxic in nature. Table 10 below shows, for four brands, data representing whether pesticides are present, a tally of non-hazardous pesticides, and a tally of hazardous pesticides. An organic score is calculated by multiplying the number of hazardous pesticides by a factor of two and then adding the number of non-hazardous pesticides to yield and Organic Score. The higher the score, the less organic a product is considered.

TABLE 10
Organic Score

| | Pesticides | | | |
|---|---|---|---|---|
| | Present | Tally of non- | Tally of | |
| | 1 = Yes | Hazardous | Hazardous | |
| Brand | 0 = No | Pesticides | Pesticides | Organic Score |
| Brand A | 0 | 0 | 0 | 0 |
| Brand B | 1 | 2 | 1 | (2) + (1*2) = 4 |
| Brand C | 0 | 0 | 0 | 0 |
| Brand D | 1 | 1 | 2 | (1) + (2*2) = 5 |

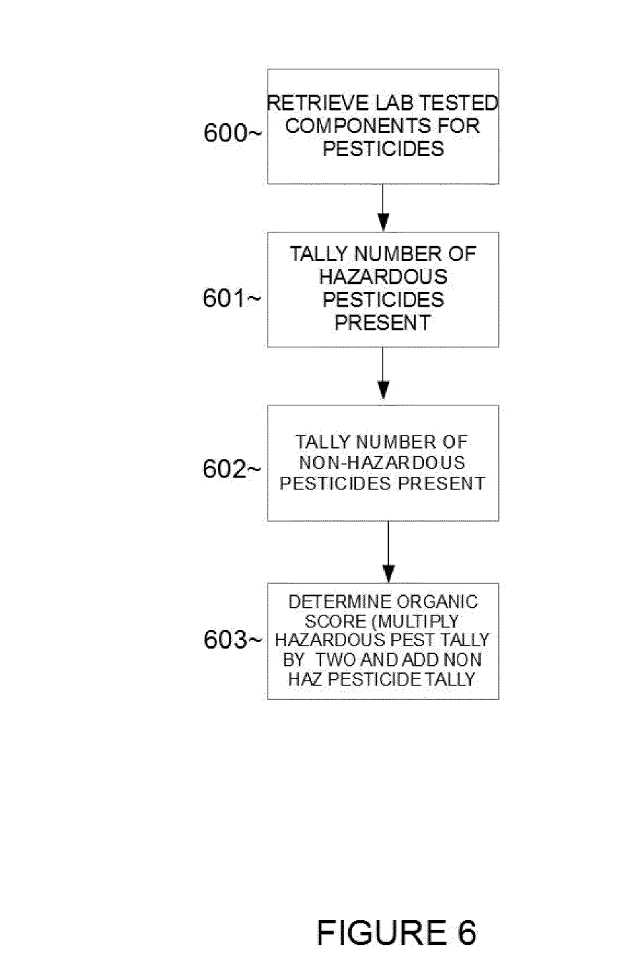

FIG. 6 is a flowchart illustrating an exemplary method of computing an organic score for a product, according to an embodiment. In operation 600, lab tested component quantities (both hazardous pesticides and non-hazardous pesticides) for a product are retrieved from a database. From operation 600, the method proceeds to operation 601 which tallies a total number of hazardous pesticides. The database can classify which pesticides are considered hazardous while which pesticides are considered non-hazardous. From operation 601, the method proceeds to operation 602 which tallies the number of non-hazardous pesticides present in the product. From operation 603, an organic score can by computed by multiplying the total number (tally) of hazardous pesticides (computed in operation 601) by two and adding the total number (tally) of non-hazardous pesticides (computed in operation 602). Thus number can then be stored in the database for future retrieval.

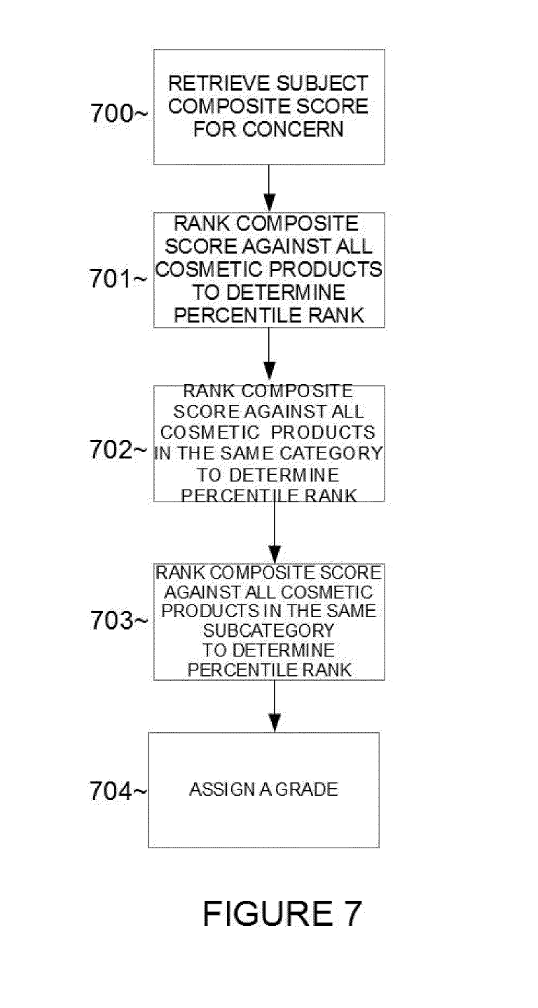

FIG. 7 is a flowchart illustrating an exemplary method of ranking a cosmetic product to assign a grade, according to an embodiment. Cumulative health risk scores, cumulative allergen risk scores, and organic scores are more desirable at lower levels. Effectiveness scores are more desirable at higher levels. The method of ranking a cosmetic to assign a grade can be implemented on the calculated cumulative health risk score, cumulative allergen risk score, organic score, and effectiveness score. For illustration, the method of assigning a grade will be discussed with respect to an allergen risk score.

In operation 700, the method retrieves the score for a particular concern (product or subject). Here, the score retrieved is a cumulative allergen risk score as calculated in Table 7. This score would be already computed and stored in the database (any database used for this purpose and available on the internet). The subject is the particular cosmetic product being ranked. The subject's cumulative allergen risk score can be retrieved by querying the database with the subject's identification (e.g., name or unique ID number) to receive the cumulative allergen risk score for the condition. The method illustrated in FIG. 7 can be performed by the same database/computer that stores all of the composite scores or it can be performed by a different computer communicating with the database.

From operation 700, the method proceeds to operation 701, wherein the cumulative allergen risk score for the concern is ranked against all cumulative allergen risk scores for cosmetic products in the database (which can be limited to only cosmetic products that are currently being offered for sale/sold on the market). The rank would be a percentile ranking where that product falls relative to all the other cosmetic products. Thus for example, ABC lip gloss can have a 75% percentile ranking for allergen risk, meaning that the cumulative allergen risk score is higher for this product than 75% of all other cosmetic products on the market.

From operation 701, the method proceeds to operation 702, wherein the cumulative allergen risk score for the concern is ranked against the cumulative allergen risk scores for all cosmetics of the same category, here makeup for lips. The rank would be a percentile ranking where the product falls relative to all lip makeup in the database. Thus, for example, ABC lip gloss can have an 80% percentile ranking for allergen risk, meaning that ABC lip gloss scores higher for this concern (allergen risk) than 80% of all other lip makeup (the subcategory.)

From operation 702, the method proceeds to operation 703, wherein the cumulative allergen risk score for the concern is ranked against the cumulative allergen risk scores for all cosmetics of the same brand, here ABC. The rank would be a percentile ranking where the cosmetic product falls relative to all cosmetic products of the same brand. Thus, for example, ABC lip gloss can have a 30% percentile ranking for allergen risk, meaning that ABC lip gloss scores higher than 35% of all the products sold by ABC. Note that with cumulative allergen risk scores, higher values represent more risk of a dermatitis reaction, and higher percentile rankings reveal higher relative risk.

From operation 703, the method proceeds to operation 704, which determines star rankings known as a Grade. A discrete number of stars (or any other indicia) can be used to provide an easy visual aid to determine a particular cosmetic products relative ranking. For cumulative allergen risk scores, the ranking is converted to a number of stars known as an AllergenGrade based on the inverted risk presented by the product. In an embodiment, dynamic stars or partial stars such as 4½ stars or other indicia can be utilized.

Table 11 illustrates one example of using a starred rating system. For a cosmetic product that has a percentile ranking of 80% to 100% (that is, is in the upper quintile) for allergen risk (see Table 10), this product would receive a one star rating representing the highest allergen risk. This is the worst rating for cosmetic products. If, for example ABC brand lip gloss received a score of 460, this would be ranked within the highest quintile as shown in Table 11, and would receive an AllergenGrade of one star. Note in the second column, “inc” means “inclusive” and “exc” means “exclusive” (i.e., 60%(inc)-80%(exc) means that the percent range for the two star rating does include 60% but does not include 80%).

TABLE 11

| Cumulative Allergen Risk | | |
|---|---|---|
| Score | Percent range | AllergenGrade (Stars) |
| 400 ≦ X ≦ 500 | 80%(inc)-100%(inc) | 1 |
| 300 ≦ X < 400 | 60%(inc)-80%(exc) | 2 |
| 200 ≦ X < 300 | 40%(inc)-65(exc) | 3 |
| 100 ≦ X < 200 | 20%(inc)-40%(exc) | 4 |
| 0 ≦ X < 100 | 0%(inc)-20%(inc) | 5 |

Thus, for every percentile ranking (e.g., operations 701, 702, 703) there would be a corresponding star rating for that ranking to make each percentile ranking easier to understand for the average consumer. The percentile ranking, as discussed herein, ranks a particular cosmetic product against its field (e.g., category, subcategory, or brand), and thus the star rating also rates the particular cosmetic product against this field.

The starred rating system illustrated in Table 11 can be printed on a cosmetic product's label so that consumers can easily visualize how good (or bad) a cosmetic product's scaled AllergenGrade score is. Each percentile ranking and starred rating requires a field that the subject cosmetic product is ranked against so the viewer knows what the context is for a percentile ranking A label can have any combination of percentile rankings, starred ratings, etc., for any combination of one or more concerns.

The exact ranges in Table 11 can be set by the certification authority (or other party) to determine which percentile ranks would qualify for five stars, four stars, etc. It can be appreciated that these ranges can be configured with different ranges as well. Once the ranges are determined, though, they should typically remain the same for consistency.

The method illustrated in FIG. 7 can be performed for the subject cosmetic product for all concerns. Thus, if there are four health concerns (e.g., allergen risk, health risk, organic score, and effectiveness score), then three percentile rankings (or any one or two out of the three) can be computed (e.g., each condition against the field of all cosmetic products, each condition against the field of all cosmetic products of the same category, and each condition against the field of all cosmetic products of the same subcategory) for 12 percentile rankings (each of the four concerns times each of the three fields) which can be stored and displayed to users. Each of these 12 percentile rankings can also have its own starred rating (e.g., using a Table such as that illustrated in Table 11). Typically, the ranges for each star rating would remain the same, regardless if different conditions and fields are used. Generally speaking, the more stars, the better the product is for consumers.

In an embodiment of the invention, a summary grade can be computed. The percentages of weight given to each concern here are exemplary and subject to change. To avoid overwhelming the consumer with too much data or too many grades, one for each concern, a summary grade can be computed that takes into account the rankings generated for each concern. In one embodiment, the health grade is weighted 50%, the effectiveness grade is weighted 30%, the allergen grade is weighted 10%, and the organic grade is weighted 10%.

Table 12 shows an example calculation of a summary grade.

| Concern | Weighting | Ranking | Weighted Ranking |
|---|---|---|---|
| Health Grade | 50% | 5 | 2.5 |
| Allergen Grade | 10% | 4 | .4 |
| Effectiveness Grade | 30% | 2 | .6 |
| Organic Grade | 10% | 3 | .3 |
| | | Summary Grade | 3.8 |

In this table, the ranking is multiplied by the weighting to calculate a weighted ranking for each row or concern. Then the weighted rankings are summed to generate the summary grade. In other words, the summary grade is a weighted average of different scores that a particular product has achieved (either scores described herein or otherwise) so that a consumer only need to look at one number to get an idea of an overall quality of a product. The summary grade is also referred to as a composite score since it combines different scores into one score.

The composite score is a numerical measure of how healthy the particular cosmetic product is considered to be. Different composite scores can be computed, one for each grade. Four main grades will be calculated Effective Grade, Safe Grade, OrganicGrade, and AllergenGrade. Effective Grade will communicate to the user the presence and amount of an effective ingredient or active ingredient. Allergen Grade will communicate to the user the presence of allergens in the product. OrganicGrade will communicate to the user the presence of non-organic (artificial) components. Safe Grade will be determined by an algorithm that includes cancer toxicity, birth defect and reproductive toxicity, neurotoxicity, endocrine toxicity, and immunotoxicity. Thus, for example a composite score for Effective Grade can be computed which is a numerical score of how high or low the presence of active ingredients is within a given cosmetic product. Composite scores will be computed for different grades. Generally, the lower the composite score for Allergen Grade and Safe Grade, the better or more desirable from a consumer standpoint. For Effective Grade, a higher composite score is generally more desirable.

A database maintained by the certification authority can store all data relating to all cosmetic products (comprising their analysis (e.g., their components and respective quantities (actual quantity and/or quantity rating)), their composite scores for safety effectiveness, or allergens. Since there are many cosmetic products for sale in this country, the sample of which to compare the cumulative health risk score is large enough to determine a relative ranking of a particular cumulative score. For example, a product can be compared against all other products that share that brand, and/or subcategory, and/or category. A product can also be compared to another particular product (e.g., another product identifier).

A database (which can be maintained by the certification authority) that stores all of the scores described herein for all (or some) cosmetic products can be made available over the internet so that users can access this data from the computers, cell phones, tablets, etc.

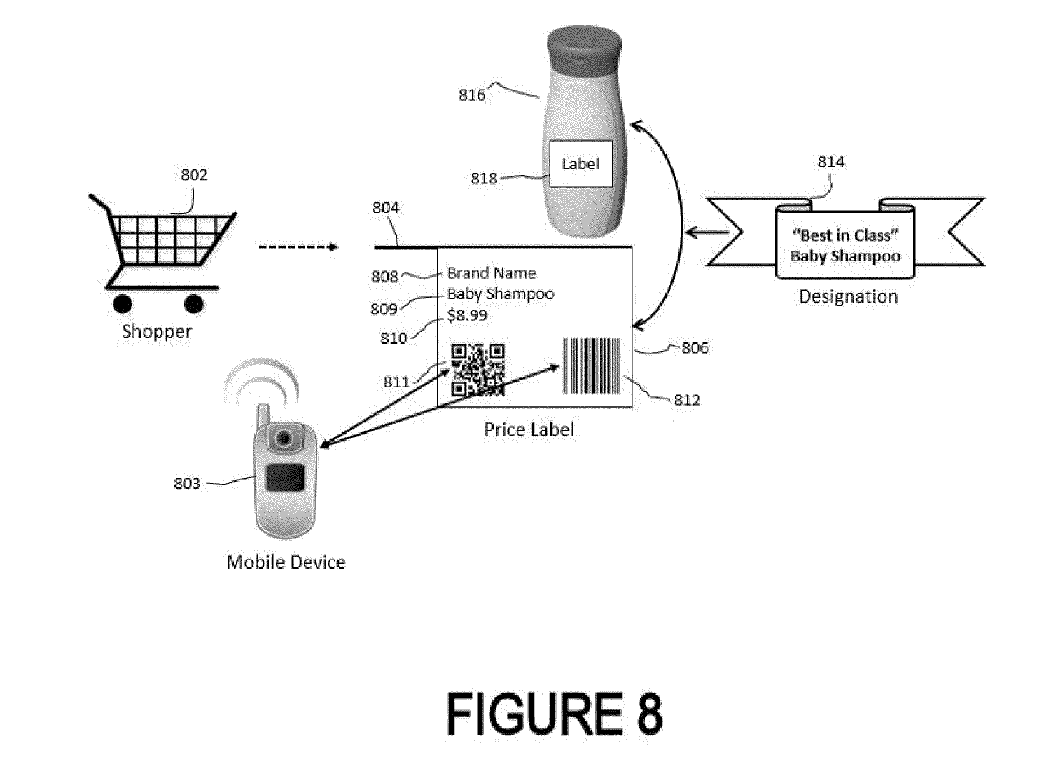

FIG. 8 is a drawing illustrating how information can be presented to a shopper, according to an embodiment.

A shopper 802 goes into a store (supermarket, etc.) and looks at a cosmetic product 816 as a potential purchase. The cosmetic product 816 has a label 818 which is placed on the product 816 by the manufacturer of the product 816. The label 818 has any information that the manufacturer wants to include or is required to label. This can include all or some of the ratings that the product 816 has received from the certification authority. The label 818 can also comprise machine readable indicia (e.g., a QR code 811 and/or a barcode 812) which when scanned by a portable computing device 803 can automatically retrieve information from the database about the product 816. In one embodiment, the portable computing device 803 can run an app which can scan a barcode (such as barcode 812) and decode it, query the database, and display the information 814 the database has about the cosmetic product 826. In another embodiment, the portable computing device 803 can scan a QR code (such a QR code 811) which would automatically visit a URL.

Any information mentioned herein can be distributed across the internet and viewed from a web browser, through an app running on a cellular phone, or any other paradigm. A web page can be set up where users can select parameters (such as any combination of category, subcategory, brand, etc.) to search for cosmetic products that meet those parameters.

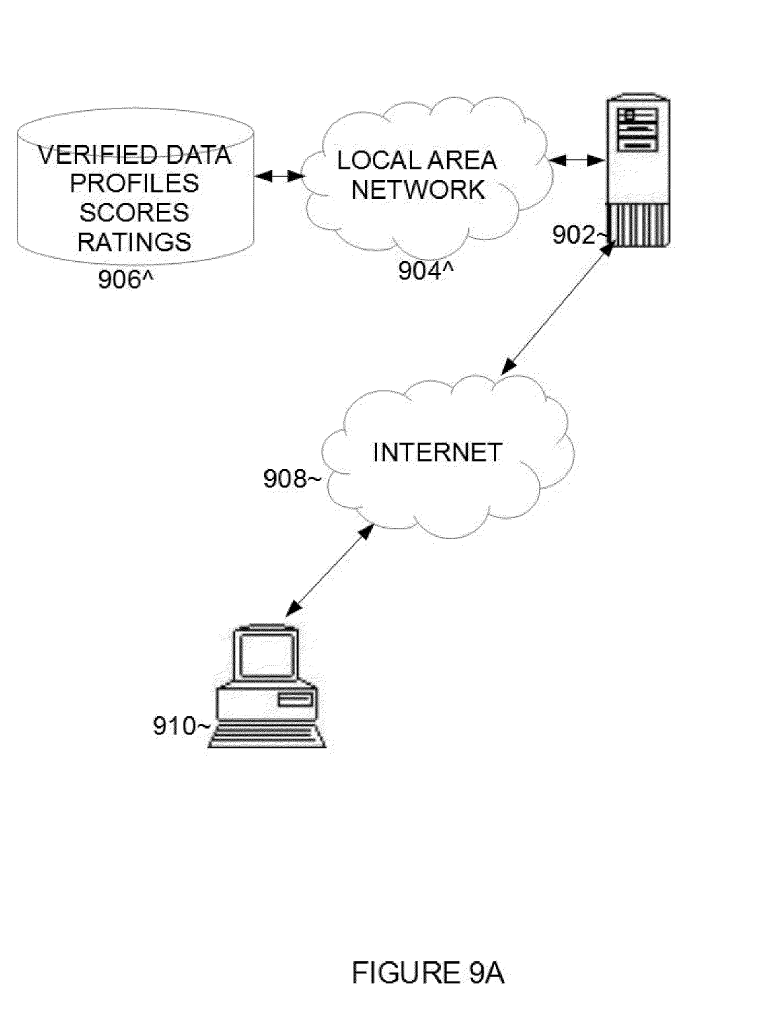

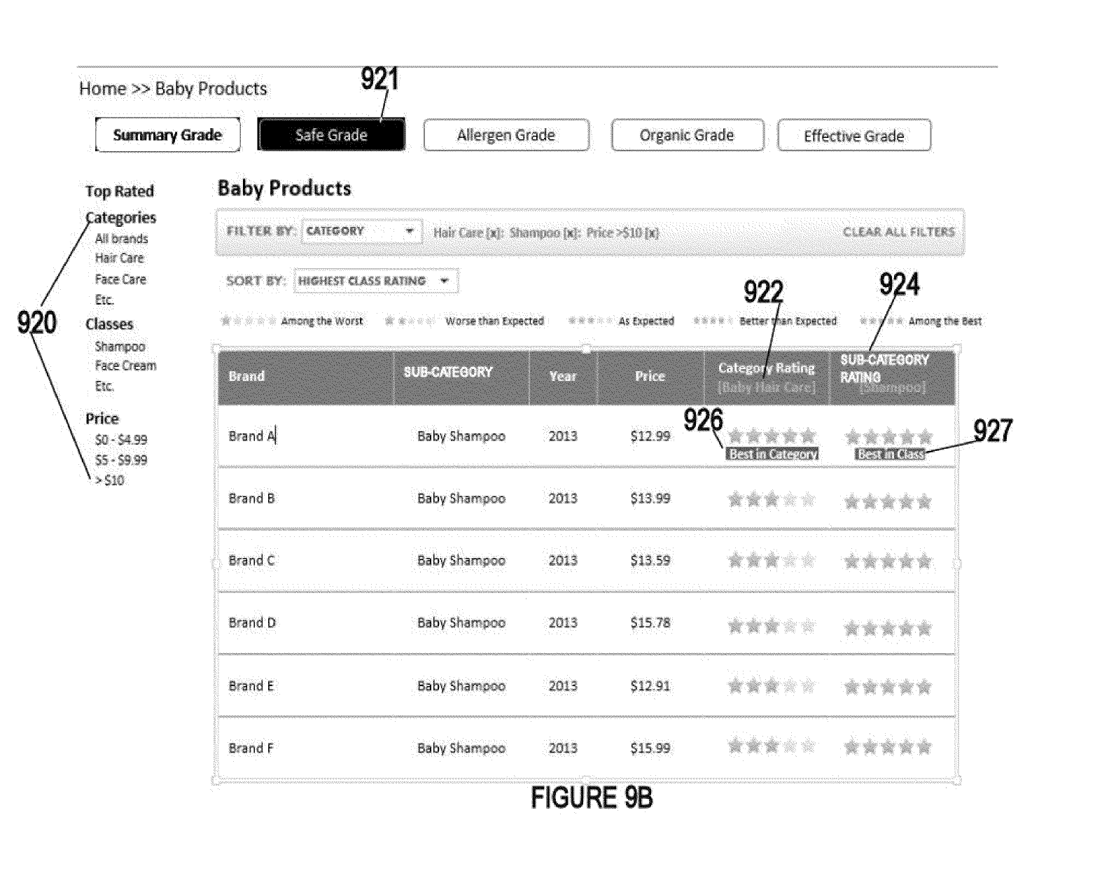

FIG. 9A is a drawing of hardware used to distribute information about cosmetic products throughout the internet, according to an embodiment. A database 906 can be used to store any and all of the data described herein. The database 906 can be any type of database, such as a relationship database (e.g., SQL). The database 906 can be connected to a LAN (local area network) 904 which is also connected to a server 902 which can serve any of the data from the database 906 to any number of individual requestors 910 via the internet 908.

FIG. 9B shows a sample web page which outputs ranking and other information about cosmetic products to a user, according to an embodiment. The web page can be served by any computer/component described herein, such as server 902 or server 200 which also can serve as the database (or is in communication with the database), the database having all of the data to enable the functionality of the sample web page described herein.

Filter buttons 920 allow the user (who can be a remote user 201, 202, or computer 1010) on a web browser to select different requirements that have to be met for a cosmetic product to appear in the list of products in the sample web page. Each displayed product can be clicked, which then brings up a web page which contains more detailed information the database stores about the cosmetic product (e.g., any of the data, scores, ratings, ranking, etc., described herein for that product). Alternatively, the user can type in any information which can identify a particular cosmetic product (e.g., a product identifier for a particular product). In addition, if the user does not identify a particular product, a user can identify a category and/or subcategory, and/or brand) which would list all products falling under the identified category and/or subcategory and/or brand and all data known for those product(s) can be transmitted to the user's computer and displayed therein.

A number of stars can be based on quintiles. In this example, the different available products are shampoos. A selected condition (e.g., “overall SafeGrade”) 921 can be selected out of a plurality of available conditions (e.g., Allergen Grade, Organic Grade, Effective Grade, etc.) to which the rankings 922, 924 are based on (each condition has its own algorithms, scoring, etc.). Column 922 displays the percentile ranking (and/or star rating) for each respective shampoo in its category and column 924 displays the percentile ranking (and/or star rating) for each respective shampoo in its sub-category. The field would be all shampoos (although in an embodiment the user can select the field). Note that scores displayed (e.g., 4 stars) represent quintiles.

A best of shampoo award 926 is displayed in the first row to indicate that that cosmetic product (“Brand A shampoo”) won the best of shampoo award for the category. A best of class award 927 is displayed in the first row to indicate that the cosmetic product (“Brand A shampoo”) won the best of shampoo for the sub-category (this award is for the best ranking cosmetic product in the subcategory shampoo for a particular concern (in this case the “SafeGrade” concern is highlighted which means it is the concern). If the user selects (clicks) the “AllergenGrade,” then a different shampoo might be shown as the best of shampoo because the scores shown in the columns 922, 924 would then reflect the percentile rankings for the AllergenGrade score which would typically be different for different concerns, risk elements, and calculation algorithm. Using the star rating system illustrated in Table 11, the Brand A shampoo would get four stars since its percentile (68%) falls in the four star range (60% to 80%). The star rating can also be displayed on the approved products window.

Note how in FIG. 9B a cosmetic product is not compared against all other cosmetic products, but only of the same subcategory (this can also be done against a plurality of categories and/or a plurality of subcategories). As discussed above, (while it can be done) to compare and rank/rate a cosmetic product against all other cosmetic products could cause anomalous results and may confuse consumers.

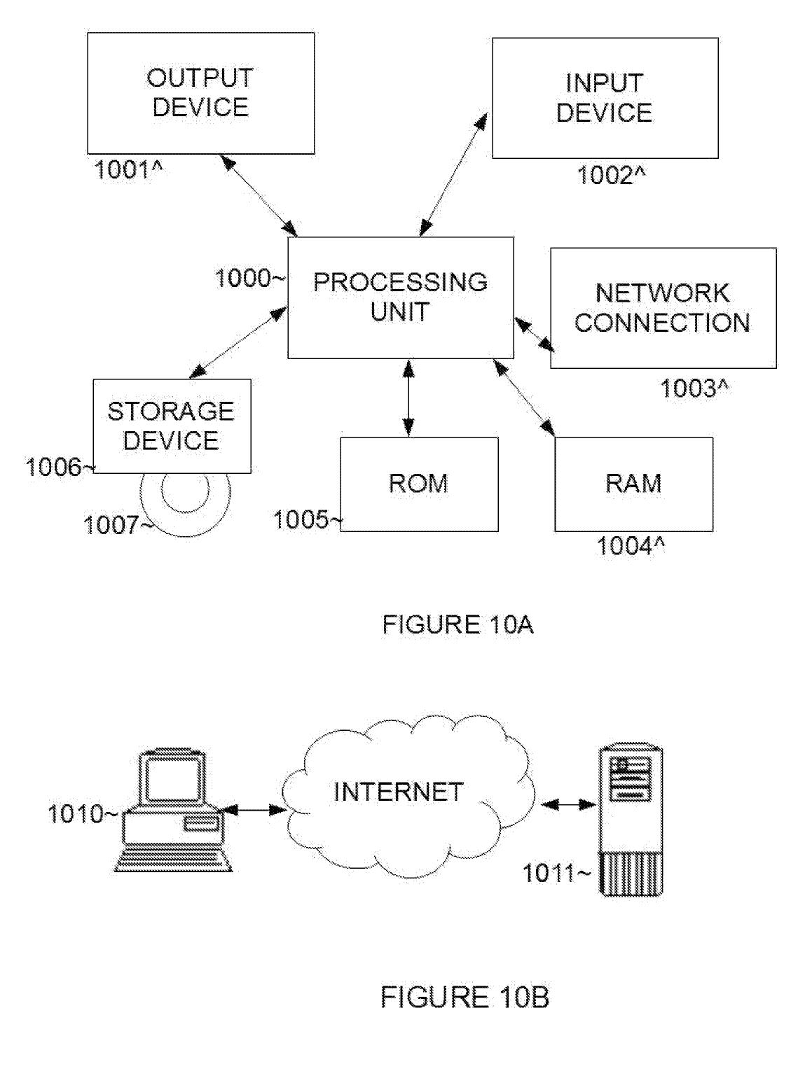

FIG. 10A is a block diagram of hardware that can be used to implement an electronic computer, according to an embodiment. The hardware illustrated in FIG. 10 can be used to implement any and all methods, features, embodiments, etc., described herein. The hardware illustrated in FIG. 10 can be used to implement any computer, portable computing device, server, database and any other electrical computing device described herein or needed to implement any and all methods, features, and embodiments described herein. In a simplest embodiment, a single such set of hardware illustrated in FIG. 10 can implement all of the embodiments described herein (e.g., a single database).

A processing unit 1000 can be a microprocessor and associated structure (e.g., cache, bus, graphics processor, etc.) which is connected to an output device 1001 (e.g., LCD, CRT, touch-screen, printer, etc.) and an input device (e.g., touch-screen, buttons, keyboard, mouse). The processing unit 1000 can read and execute instructions that can perform any and all of the methods/features described herein. The input device 1002 can be used to receive any input needed from a user/shopper described herein, and the output device 1001 can be used to display any output from any electronic device described herein. Any value computed/described herein (e.g., any quantity or information described herein, including but not limited to percentile rankings, starred ratings, including the subject beverage and respective field, can be displayed on the output device and also transmitted (transmitted and/or received) via the network connection 1003). A network connection 1003 is used to connect the processing unit 1000 to one or more computer communications networks (e.g., the internet, LAN, WAN, Wi-Fi, cellular data network, etc.) The processing unit 1000 can also be connected to a ROM 1005 and a RAM 1004. The processing unit 1000 can also be connected to a storage device 1006 such as a CD-ROM drive, hard drive, BLU-RAY Drive, flash memory, etc. The storage device 1006 can read/write to a non-transitory computer readable storage medium 1007 such as a CD-ROM, hard disc, BLU-RAY disc, flash memory chip, etc. The non-transitory storage medium 1007 can store programs and data to implement any of the methods/features described herein. The ROM 1005 and/or RAM 1004 can also store programs and data to implement any of the methods/features described herein.

It is further noted that any electronic component described herein (e.g., computer, server, database, etc.) can also be split up into multiple components (which operate in the same physical location or different physical locations and communicate via any type of computer communications network) to accomplish any of its operations. Different databases can communicate and cooperate with each other in the sharing of data to effectuate any of the methods described herein. For example, the contents of all cosmetic products (components and their quantities) can be stored by one database while all of the scores (e.g., composite scores) for all of the cosmetic products can be computed and stored by a second database. It does not matter for purposes of effectuating the embodiments described herein whether one or more databases, computers, servers, etc. is used.

In FIG. 10B computer 1010 (e.g., any personal computer, tablet, cell phone, etc.) can connect to a server 1011 via the Internet. The server 1011 can include (or be connected to) a database which stores all of information/data described herein (e.g., all of the composite scores, components and respective quantities, ratings, and any other data described herein, for all cosmetic products which can be retrieved by the computer and then displayed).

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a (non-transitory) computer readable storage medium to control a computer. Programs and/or data required to implement any of the methods/features described herein can all be stored (and executed therefrom to perform any of the methods/features) on any non-transitory computer readable storage medium (volatile or non-volatile, such as CD-ROM, RAM, ROM, EPROM, microprocessor cache, etc.)

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to evaluate cosmetic products, the method comprising:
receiving an analysis of contents of a cosmetic product, said analysis comprising components and their respective quantities or intensities;
determining, based on the components and their respective quantities or intensities, a cumulative health risk score of the cosmetic product;
calculating a rating of the cosmetic product based on the relative ranking of said health risk score of the cosmetic product; and
publishing the rating.

2. The method as recited in claim 1, wherein the publishing the rating distributes the rating using an electronic server connected to the internet configured to display the rating on remote personal computers.

3. The method as recited in claim 2, wherein the rating incorporates toxicity of the cosmetic product.

4. A method to evaluate cosmetic products, the method comprising:
executing computer readable instructions on an electronic processing unit that perform the following operations:
receiving contents, for a subject cosmetic product, the contents comprising a plurality of components and their respective quantities or intensities;
identifying a set of risk weights for components and associated conditions for each component;
determining a score for the subject cosmetic product by applying the weights for each component in the contents of the subject cosmetic product to a respective quantity or intensity of the component in the subject cosmetic product; and
storing the score in a database and publishing the score on the Internet

5. The method as recited in claim 4, further comprising ranking the score of the subject cosmetic product among scores of other cosmetic products in a field of cosmetic products.

6. The method as recited in claim 5, wherein the field of cosmetic products comprises only all cosmetic products of a same category as the subject cosmetic product.

7. The method as recited in claim 5, wherein the field of cosmetic products comprises only all cosmetic products of a same subcategory and category as the subject cosmetic product.

8. The method as recited in claim 4, further comprising receiving a query from a user to define the field, the query entered as relational calculus or relational algebra.

9. The method as recited in claim 5, wherein the ranking is a percentile ranking.

10. The method as recited in claim 9, further comprising determining a rating of the subject cosmetic product, the rating comprising a quantity of indicia, more indicia being better and one indicia being worst, the rating determined based on the percentile ranking, wherein each number of indicia corresponds to a range of values for the percentile ranking.

11. An apparatus to evaluate cosmetic products, the apparatus comprising:
an electronic input device;
an electronic output device;
a processing unit connected to the input device and the output device, the processing unit configured to perform:
storing, for each component in a set of components, a respective risk weighting, exposure weights, and threshold levels;
receive contents, for a subject cosmetic product, the contents comprising a plurality of components and their respective quantities or intensities;
determining a level of each of the plurality of components in the subject cosmetic product based on which of the threshold levels the respective quantity or intensity of the component falls into;
determining a score for a component in the subject cosmetic product by multiplying the component's respective level times the component's respective risk weighting times the component's respective exposure weight;
summing all scores for all components in the subject cosmetic product into an overall score; and
storing the overall score in a database and publishing the overall score on the Internet.

12. The apparatus as recited in claim 11, wherein the processing unit is further configured to perform ranking the overall score of the subject cosmetic product among overall scores of other cosmetic products in a field of cosmetic products.

13. The apparatus as recited in claim 12, wherein the processing unit is further configured such that the field of cosmetic products comprises only all cosmetic products of a same category as the subject cosmetic product.

14. The apparatus as recited in claim 12, wherein the processing unit is further configured such that the field of cosmetic products comprises only all cosmetic products of a same category and subcategory as the subject cosmetic product.

15. The apparatus as recited in claim 12, wherein the processing unit is further configured such that the ranking is a percentile ranking.

16. The apparatus as recited in claim 15, wherein the processing unit is further configured to determine a rating comprising a quantity of indicia, more indicia being better and one indicia being worst, the rating determined based on the percentile ranking, wherein each number of indicia corresponds to a range of values for the percentile ranking.

17. The apparatus as recited in claim 12, wherein the processing unit is further configured to receive a query from the user to define the field, the query entered as relational calculus or relational algebra.
